(19) United States
(12) Patent Application Publication
(10) Pub. No.: US 2008/0014385 A1
(43) Pub. Date: Jan. 17, 2008

(54) PACKAGE SHELL COVER LAYER AND ITS PROCESSING PROCEDURE

(76) Inventor: Pao-Chuan Huang, Taipei City (TW)

Correspondence Address: Pao Chuan Huang, 235 Chung - Ho Box 8-24, Taipei, Taiwan, R. O. C., Taipei, 235, TW

(21) Appl. No.: 11/779,891

(22) Filed: Jul. 19, 2007

Related U.S. Application Data
(63) Continuation-in-part of application No. 10/785,593, filed on Feb. 23, 2004, now abandoned.

(51) Int. Cl. B31B 45/00

(52) U.S. Cl. 428/34.1

(57) ABSTRACT

A package shell cover layer formed of a thin sheet base material by printing the thin sheet base material with a color design and molding the printed thin sheet base material through a hot press mold to form a semi-finished cover layer having a cover layer main body and a peripheral material extended around the border of the cover layer main body and an extension portion suspended between the border of the cover layer main body and the peripheral material.

The present invention is a continuation in part (CIP) of U.S. patent application Ser. No. 10/785,593. The contents of the U.S. patent application Ser. No. 10/785,593 are incorporated into the present invention as a part of the present invention.

### BACKGROUND OF THE INVENTION

1. Field of the Invention

The present invention relates to a package shell cover layer that prevents cracking of the printed design and curving of the border edge when cut from the peripheral material.

2. Description of the Related Art

The design of the package shell of an electric appliance is one of the important factors to attract consumers to boy the electric appliance. The color design of the package shell of an electric appliance may be formed on the package shell by transfer-printing. However, the color design may by transfer-printing wears quickly with the use of the electric appliance. In order to eliminate this problem, an improved method is developed. According to this improved method, a thin sheet plastic base material is prepared and then printed with a color design, and then the printed thin sheet plastic base material is put in a hot press mold and molded into a semi-finished product that has a cover layer main body with the printed color design and a peripheral material extended around the border area of the cover layer main body. The semi-finished product is then well cut to separate the cover shell main body from the peripheral material. However, this method still has drawbacks. During hot press molding, the cohesive force of the thin sheet base material is changed, resulting in cracking of the printed color design about the border area of the cover layer main body. After cutting of the cover layer main body from the peripheral material, the cut border edge of the cover layer main body tends to curve inwards. When put the edge-curved cover layer main body in the mold of an injection molding machine and then molded on the package shell of an apparatus, the molded package shell may become defective.

For easy understanding of the improvement of the present invention on conventional design, pictures are attached for reference. FIG. 6(A) shows a backside of a coating layer of a conventional half product, FIG. 6(B) shows the partial enlarged view of the prior art and FIG. 6(C) shows the front partial enlarged view of the prior art. As indicated, cracks of printing are seen in the cut line around the border of the cover layer of the semi-finished product. When separated from the peripheral material by cutting, the cut border area of the cover layer will be turned inwards. When put in the mold of an injection molding machine and then molded on the package shell of an apparatus, the molded package shell may become defective.

### SUMMARY OF THE INVENTION

The present invention has been accomplished under the circumstances in view. It is therefore the main object of the present invention to provide a package shell cover layer, which improves the sense of beauty of the package shell and reinforces the toughness of the package shell. It is another object of the present invention to provide a package shell cover layer, which prevents cracking of the printed color design and curving of the cut border edge. According to one aspect of the present invention, the package shell cover layer is formed of a thin sheet base material by printing the thin sheet base material with a color design and molding the printed thin sheet base material through a hot press mold to form a semi-finished cover layer having a cover layer main body and a peripheral material extended around the border of the cover layer main body and an extension portion suspended between the border of the cover layer main body and the peripheral material and sloping (or curved) downwards toward the peripheral material. According to another aspect of the present invention, the package shell cover layer processing procedure comprises the steps of a) preparing a thin sheet base material; b) printing a color design on the thin sheet base material; and c) putting the printed thin sheet base material in a hot press mold, and then molding the printed thin sheet base material into a semi-finished product having a cover layer main body, a peripheral material extended around the border of the cover layer main body, and an extension portion suspended between the border of the cover layer main body and the peripheral material, and then cutting the border area of the cover layer main body to separate the cover layer main body from the extension portion and the peripheral material after removal of the semi-finished product from the hot press mold.

### BRIEF DESCRIPTION OF THE DRAWINGS

FIG. 1 is a block diagram showing a package shell cover layer processing flow according to the present invention.

FIG. 2 is a schematic drawing showing a color design printed on a thin sheet base material prepared according to the present invention.

FIG. 3 is a schematic sectional view showing the molding of a printed thin sheet base material in a hot press mold according to the present invention.

FIG. 4 is a schematic drawing showing a semi-finished cover layer according to the present invention.

FIG. 5 is an elevational view of a cover layer obtained according to the present invention.

### DETAILED DESCRIPTION OF THE PREFERRED EMBODIMENT

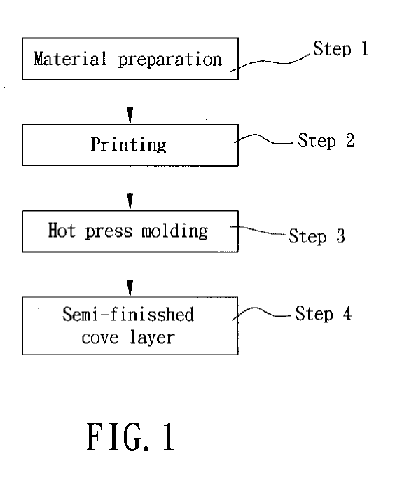

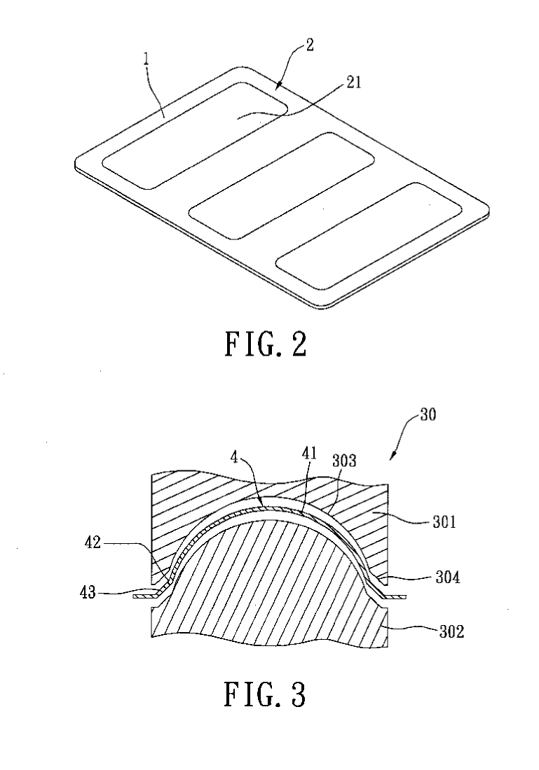

Referring to FIGS. 1, 2, and 3, a package shell cover layer is a layer carrying a color design to improve the sense of beauty of the package shell and to reinforce the toughness of the package shell.

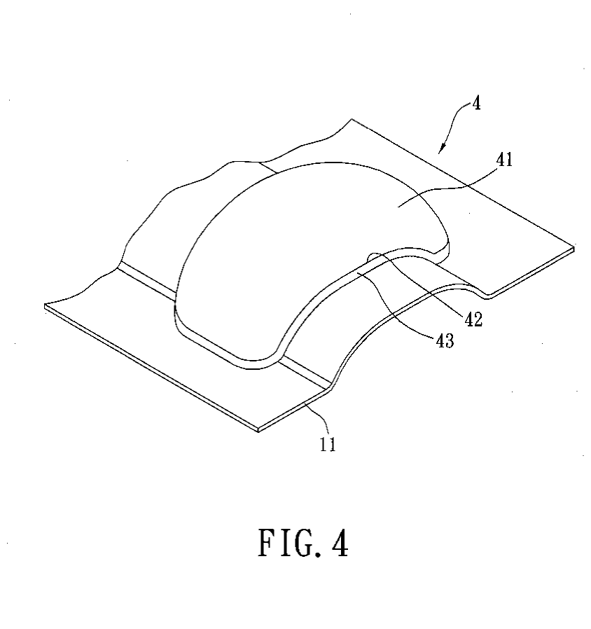

The processing process of making the aforesaid package shell cover layer includes the first step of material preparation 1 where a thin sheet base material (indicated also by numeral sign 1) is prepared, the second step of printing 2 where a printing machine is used to print a color design (for example the logo of a company) 21 on the surface of the prepared thin sheet base material 1, the third step of hot press molding 3 where the printed thin sheet base material 1 is put in the male die 301 and female die 302 of a hot press mold 30, and the fourth step of removal of semi-finished cover layer 4 where a semi-finished cover layer 4 is obtained and removed from the hot press mold 30. (see FIG. 4).

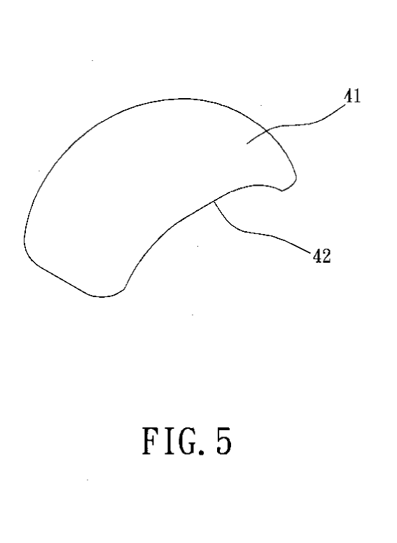

Referring to FIGS. 4 and 5, the semi-finished cover layer 4 thus obtained comprises a cover layer main body 41, a peripheral material 11 formed of a part of the thin sheet base material 1, and an extension portion 43 connected between the border 42 of the cover layer main body 41 and the peripheral material 11. The extension portion 43 slopes (or curves) downwards from the border 42 of the cover layer main body 41 toward the peripheral material 11. The semi-finished cover layer 4 is then properly cut along the border 42 of the cover layer main body 41 to separate the cover layer main body 41 from the peripheral material 11. The singulated cover layer main body (finished cover layer) 41 is then put in the mold of an injection molding machine and then molded on the package shell of an apparatus. When molded on the package shell of an apparatus, the cover layer main body 41 improves the sense of beauty of the apparatus and reinforces the toughness of the package shell of the apparatus.

The cavity of the hot press mold 30 comprises a cover layer molding area 303 adapted to mold the middle part of the thin sheet base material 1 into the aforesaid cover layer main body 41, and an extension portion molding area 304 adapted to mold a part of the thin sheet base material 1 into the aforesaid extension portion 43 around the border 43 of the cover layer main body 41. During hot press molding, the cohesive force of the thin sheet base material 1 remains unchanged, therefore cutting the border area 42 of the cover layer main body 41 from the peripheral material 11 does not cause cracking of the printing around the border area 42 of the cover layer main body 41 or inward turning of the cut border edge of the cover layer main body 41. When put in the mold of the injection molding machine, the cover layer main body 41 can be molded on the package shell of an apparatus smoothly and successfully. Because of high yielding rate, the manufacturing cost is relatively reduced.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A package shell cover layer comprising
a thin sheet base material printed with a color design and molded through a hot press mold to form a semi-finished cover layer having
a cover layer main body having a cross-sectional shape configured for molding unto a package shell;
a peripheral material extended in a general horizontal plane, having an outer peripheral boundary and an inner peripheral boundary;
a border, elevated above said peripheral material, and shaped to conform to the edge of said cover layer main body; and
a flared extension portion, formed of said thin sheet base material, connecting said border to said inner peripheral boundary of said peripheral material;
wherein an outer edge of said package shell cover layer is subsequently formed when said peripheral material and said extension portion are trimmed away along said border.

2. The package shell cover layer as claimed in claim 1, wherein said extension portion slopes downwards from the border of said cover layer main body toward said peripheral material.

3. The package shell cover layer as claimed in claim 1, wherein said extension portion curves from the border of said cover layer main body toward said peripheral material.

4. The package shell cover layer as claimed in claim 1, wherein said thin sheet base material is a thin sheet plastic material.

5. A package shell cover layer processing procedure comprising the steps of:
a) preparing a thin sheet base material;
b) printing a color design on said thin sheet base material; and
c) putting the printed thin sheet base material in a hot press mold, and then molding the printed thin sheet base material into a semi-finished product having a cover layer main body, a peripheral material extended around the border of said cover layer main body, and an extension portion suspended between the border of said cover layer main body and said peripheral material, and then
d) cutting the border area of said cover layer main body to separate said cover layer main body from said extension portion and said peripheral material after removal of said semi-finished product from said hot press mold.

6. The package shell cover layer processing procedure as claimed in claim 5, wherein said hot press mold is comprised of a male die and a female die, defining therein a cavity having a cover layer molding area adapted to mold a middle part of said thin sheet base material into said cover layer main body and an extension portion molding area adapted to mold a part of said thin sheet base material into said extension portion.

7. The package shell cover layer processing procedure as claimed in claim 5, wherein said hot press mold is comprised of a single die defining therein a cavity having a cover layer molding area adapted to mold a middle part of said thin sheet base material into said cover layer main body, and an extension portion molding area adapted to mold a part of said thin sheet base material into said extension portion.
